(19) United States
(12) Patent Application Publication
(10) Pub. No.: US 2023/0193693 A1
(43) Pub. Date: Jun. 22, 2023

(54) STEP IRON IMPROVEMENTS

(71) Applicant: STEPLOCK PTY LTD, Moolap (AU)

(72) Inventors: Patrick MOULTON, Leopold (AU); Paul MURPHY, Richmond (AU); John HOLMES, Geelong (AU)

(21) Appl. No.: 17/925,359

(22) PCT Filed: May 20, 2021
(86) PCT No.: PCT/AU2021/050472

§ 371 Date: Nov. 15, 2022

(30) Foreign Application Priority Data
May 20, 2020 (AU) 2020901634

(51) Int. Cl. E06C 9/04; B29C 45/14; E06C 7/08; E06C 7/50

(52) U.S. Cl. CPC E06C 9/04; B29C 45/14; E06C 7/081; E06C 7/50; B29K 2023/06; B29K 2023/12

(57) ABSTRACT

A step iron for a concrete structure, the step iron comprising a body and a leg; the body and leg each comprising a metal core and at least partially encapsulated in a polymer material; the body comprising a tread length to enable a user to use the step iron for climbing; the leg comprising a proximal end nearer the body and a distal end; the distal end of the leg comprising an end section to abut a complementary section of an insert which is fixable and embeddable within a concrete structure; a fixing means mounted on the leg to enable reversible engagement with a complementary section of the insert.

### BACKGROUND OF THE INVENTION

Individual ladder rungs, or step irons as they are commonly known, have been used in the civil industry for many years. They are used for access into concrete structures used for stormwater drainage, electrical, telecommunications, gas, and other applications. Step irons are generally set at vertical spacings of approximately 300 mm down the inside face of the wall of the structure to allow the entry by a person into that structure in a safe manner.

Step irons can be fitted to concrete structure walls in several ways. Some of the most common fixing methods are:
(a) A cavity the same diameter as the leg of the step iron will be either drilled or pre-formed in the concrete wall. The step iron is then fitted into the wall by force with a hammer or similar. The securing of the step rung to the wall can be aided by either an epoxy or mortar product inserted into the cavity prior to hammering the step iron leg in.
(b) In the case of pre-cast structures, a plastic step plug can be cast into the concrete wall. Again, the step iron is inserted by force into the plug. This type of fixing can also be assisted using an epoxy product inside the plug prior to insertion of the step iron leg.
(c) Step irons can also be directly cast into the concrete walls of the structure before the concrete has set hard through pre-drilled holes in the structure formwork. While this method results in a secure step in the structure wall the method often results in costly formwork only having a single use.

The problems that arise for these traditional step iron fixing methods are varied and include for example:
1. In methods (a) and (b) above, the step iron relies on an interference fit into a cavity. It also can rely heavily on the integrity of the concrete and any spoiling of concrete around the cavity can result in the step leg becoming loose and breaking away under force when a person applies weight to it. This can cause the step to release from the wall of the structure as a person enters and there is a potential to cause injury to that person from falling.
2. Even with an epoxy or mortar product inserted into the cavity prior to installation of the step iron leg there is the potential that the epoxy or mortar may not bond sufficiently with the step iron leg and/or the concrete of the structure which could result in the step iron becoming unstable and pulling out of the wall during human entry without notice. Such a failure to bond can occur in a number of circumstances, for example:
   a. The mortar or epoxy product may not be mixed correctly, resulting in the bond strength of the product not developing sufficiently.
   b. Moisture will impact mortar in the same way adding too much water to concrete significantly reduces its strength, It can also impact the ability of an epoxy to bond to a substrate.
   c. Dirt and debris cause problems for bonding to a substrate too, in particular for epoxy products. Most installation guides, in particular for epoxy products will specify that any cavity where product is to be inserted is blown out and dried to remove dirt, debris and moisture.
3. 4. The type of plastic used in the step will also impact the bond. For example it is quite difficult for epoxy or mortar products to bond strongly to polypropylene due to their respective chemical properties.
4. Drilling holes in the wall of a concrete structure can potentially cause damage to the steel reinforcement within the wall, potentially compromising the structural integrity of the whole structure.
5. In many cases step irons that have been fitted are removed after the structure is installed due to minimal workspace inside the structure when attempting to complete other work inside the structure e.g. connection of pipes or maintenance operations. Once the work has been completed the step is then replaced but given this installation method relies on an interference fit, the same integrity cannot be assured. Further, it is not possible with existing products to determine if a step has been removed and re-inserted in the event of a failure.

The fixing methods described above in the present state of art cannot guarantee ongoing compliance with relevant safety requirements. In particular that of pull out forces which are critical to ensuring the safety of any person using step irons to access a structure. The permanent fixing of step irons using an epoxy or grout is also disadvantageous and problematic for persons entering the structures to undertake other works inside the structures due to restricted workspaces and the inability to remove and re-install the step irons. Further, there is no means of ascertaining if a step iron has been removed and replaced.

Attempts have been made to improve the traditional ways in which step irons have been secured to concrete structure walls as described above to allow the removal and re-insertion of step irons into the structure walls. In particular, there have been attempts to use various methods or designs of threaded components to secure step irons to the concrete structure walls. There remains in this disclosed knowledge varied problems. For example:
A. The threaded components do not create a direct mechanical means for securing the step iron to the concrete structure wall. Rather, the methods provide for a threaded component to exert pressure and interference fit on the legs of the step irons, presenting the same problem relating to interference fit as described above. An example of this is described in Japanese patent application number JP2001055881A.
B. The components are required by virtue of the design to be manufactured and/or machined from a metal material that is exposed for example to weather or other corrosive substances inside the structure e.g. chemicals in water or liquids inside structures, gas inside structures, sewage in sewer chambers etc. This creates potential problems with corrosion compromising the structural integrity and therefore the safety of the step iron. Examples of products which have this problem are described in Japanese patent application numbers JP2001055881A, JP2002250045A and U.S. Pat. No. 490,362A
C. The components are required by virtue of the design to be manufactured completely from synthetic materials. This creates a problem where the design will not meet current safety standards, in particular strength requirements to support the weight of a person on the step. An example of a product with this problem is disclosed in Japanese patent application number JPH10-280458A.
D. The design requires the embedded and/or threaded component to protrude through the inner structure formwork. This method creates the same problem as disclosed above in the traditional fixing methods where costly formwork is single-use. Additionally, this method cannot be used in pre-cast concrete structures where steel formwork is used and there is no practical way to accommodate components protruding through the formwork. Examples of product with these problems are disclosed in patents South Korean patent application number KP2000-0071885A, Japanese patent application number JPH10-280458A and U.S. Pat. No. 490,362A.
E. The method of securing relies on hidden and/or unseen components within the assembly. Incorrect installation and/or tampering would render the step iron completely unsecured to the concrete structure wall and would not be able to be detected by the naked eye. This creates a serious potential safety risk to any persons entering the concrete structures. Products with this problem are disclosed in Japanese patent application number JP2002250045A and United States of America patent number U.S. Pat. No. 4,903,62A.

The reference to any prior art in this specification is not, and should not be taken as, an acknowledgement or any form of suggestion that the prior art forms part of the common general knowledge.

### SUMMARY OF THE INVENTION

According to one aspect of the invention, there is provided a step iron for a concrete structure, the step iron comprising a body and a leg; the body and leg each comprising a metal core and at least partially encapsulated in a polymer material; the body comprising a tread length to enable a user to use the step iron for climbing; the leg comprising a proximal end nearer the body and a distal end; the distal end of the leg comprising an end section to abut a complementary section of an insert which is fixable and embeddable within a concrete structure; a fixing means mounted on the leg to enable reversible engagement with a complementary section of the insert.

The step iron may comprise a plurality of legs. The step iron may comprise a metal core fully encapsulated in a plastic material. It may also comprise an elongate tread length to enable a user to use the step iron for climbing.

In some embodiments, the distal end of each leg comprises an end section to abut an insert which is fixable within formwork and embeddable within a concrete structure without protruding therefrom. The step iron may comprise a locking ring centrally located on the axis of each leg just proximal to the end section. The step iron may also comprise a plastic ferrule nut slidably mounted on each leg proximal to a locking ring, such nut comprising an external thread which is complementary to that of the insert and a means for gripping the nut so that the nut can be tightened on the thread of said insert so as to securely but reversibly hold the step iron in place on the concrete structure.

Some embodiments comprise vertical upstands located substantially laterally on the tread length to prevent a person's foot slipping off the end of the step iron. In some embodiments, the rear of the tread length comprises a series of raised profiles to improve the handhold of a person gripping the tread length in use. The distal end of the leg may comprise an end section to abut a complementary section of a substantially ring-shaped polypropylene or polyethylene insert which comprises an internal thread and a plurality of apertures to enable it to be fixed within formwork and embeddable within a concrete structure without protruding therefrom. In some embodiments, the step iron comprises a locking ring centrally located on the axis of each leg just proximal to the end section, the locking ring being able to withstand a force of 5 kN.

The step iron may comprise a plastic ferrule nut slidably mounted on each leg proximal to each locking ring, such nut comprising an external thread which is complementary to that of the insert and a plurality of pre-formed holes for gripping the nut so that the nut can be tightened on the thread of said insert so as to securely but reversibly hold the step iron in place on the concrete structure in such a manner so that the security of such hold is visible to the naked eye. In some embodiments, the nut comprises a tamper-evident cavity adapted to disfigure said plastic of the nut if an attempt is made to remove the step after initial installation.

The invention also provides a step iron for a concrete structure, the step iron being of substantially U-shape and comprising a body and a plurality of legs, the body and legs each comprising a steel core fully encapsulated in high impact polypropylene or high density polyethylene; the body comprising an elongate tread length to enable a user to use the step iron for climbing; the step iron comprising vertical upstands located substantially laterally on the tread length to prevent a person's foot slipping off the end of the step iron, said upstands being approximately 25 mm in height and approximately 59 mm in length; the rear of the tread length comprising a series of raised profiles to improve the handhold of a person gripping the tread length in use; the legs each comprising a proximal end nearer the body and a distal end; the distal end of each leg comprising an end section to abut a complementary section of a substantially ring-shaped polypropylene or polyethylene insert which comprises an internal thread and a plurality of apertures to enable it to be fixed within formwork and embeddable within a concrete structure without protruding therefrom; a disc shaped locking ring centrally located on the axis of each leg just proximal to the end section, the locking ring being able to withstand a force of 5 kN and being approximately 40 mm in diameter and approximately 6.8 mm thick; a polypropylene or polyethylene ferrule nut slidably mounted on each leg proximal to each locking ring, such nut comprising an external thread which is complementary to that of the insert and a plurality of pre-formed holes for gripping the nut so that the nut can be tightened on the thread of said insert so as to securely but reversibly hold the step iron in place on the concrete structure in such a manner so that the security of such hold is visible to the naked eye; wherein the preformed holes are approximately 5 mm in diameter and the nut comprises a tamper-evident cavity of approximately 10 mm length such that the plastic of the nut within the cavity and adjacent to each such hole is of 2 mm thickness, the cavity thereby adapted to disfigure said plastic of the nut if an attempt is made to remove the step after initial installation.

The invention also provides a step iron for a concrete structure, the step iron comprising a body and a plurality of legs; the body and legs each comprising a metal core fully encapsulated in a plastic material; the body comprising an elongate tread length to enable a user to use the step iron for climbing; the legs each comprising a proximal end nearer the body and a distal end; the distal end of each leg comprising an end section to abut an insert which is fixable within formwork and embeddable within a concrete structure without protruding therefrom; a locking ring centrally located on the axis of each leg just proximal to the end section; a plastic ferrule nut slidably mounted on each leg proximal to each locking ring, such nut comprising an external thread which is complementary to that of the insert and a means for gripping the nut so that the nut can be tightened on the thread of said insert so as to securely but reversibly hold the step iron in place on the concrete structure.

The invention also provides a step iron for a concrete structure, the step iron comprising a body and a plurality of legs; the body and legs each comprising a steel core fully encapsulated in a plastic material; the body comprising an elongate tread length to enable a user to use the step iron for climbing; the step iron comprising vertical upstands located substantially laterally on the tread length to prevent a person's foot slipping off the end of the step iron; the rear of the tread length comprising a series of raised profiles to improve the handhold of a person gripping the tread length in use; the legs each comprising a proximal end nearer the body and a distal end; the distal end of each leg comprising an end section to abut a complementary section of a substantially ring-shaped polypropylene or polyethylene insert which comprises an internal thread and a plurality of apertures to enable it to be fixed within formwork and embeddable within a concrete structure without protruding therefrom; a locking ring centrally located on the axis of each leg just proximal to the end section, the locking ring being able to withstand a force of 5 kN; a plastic ferrule nut slidably mounted on each leg proximal to each locking ring, such nut comprising an external thread which is complementary to that of the insert and a plurality of pre-formed holes for gripping the nut so that the nut can be tightened on the thread of said insert so as to securely but reversibly hold the step iron in place on the concrete structure in such a manner so that the security of such hold is visible to the naked eye; wherein the nut comprises a tamper-evident cavity adapted to disfigure said plastic of the nut if an attempt is made to remove the step after initial installation.

In another aspect of the invention, there is provided a step iron apparatus for a concrete structure comprising an insert and a step iron: the insert being fixable and embeddable within a concrete structure; the step iron comprising a body and a leg; the body and leg each comprising a metal core and at least partially encapsulated in a polymer material; the body comprising a tread length to enable a user to use the step iron for climbing; the leg comprising a proximal end nearer the body and a distal end; the distal end of the leg comprising an end section to abut a complementary section of the insert; a fixing means mounted on the leg to enable reversible engagement with a complementary section of the insert.

The step iron apparatus may comprise a plurality of legs and it may comprise a metal core fully encapsulated in a plastic material. The body may comprise an elongate tread length to enable a user to use the step iron for climbing. The the distal end of each leg may comprise an end section to abut an insert which is fixable within formwork and embeddable within a concrete structure without protruding therefrom. The step iron apparatus may comprise a locking ring centrally located on the axis of each leg just proximal to the end section.

The step iron apparatus may comprise a plastic ferrule nut slidably mounted on each leg proximal to a locking ring, such nut comprising an external thread which is complementary to that of the insert and a means for gripping the nut so that the nut can be tightened on the thread of said insert so as to securely but reversibly hold the step iron in place on the concrete structure. It may also comprise vertical upstands located substantially laterally on the tread length to prevent a person's foot slipping off the end of the step iron. In some embodiments, the rear of the tread length comprises a series of raised profiles to improve the handhold of a person gripping the tread length in use.

In some embodiments, the distal end of the leg comprises an end section to abut a complementary section of a substantially ring-shaped polypropylene or polyethylene insert which comprises an internal thread and a plurality of apertures to enable it to be fixed within formwork and embeddable within a concrete structure without protruding therefrom.

The step iron apparatus may comprise a locking ring centrally located on the axis of each leg just proximal to the end section, the locking ring being able to withstand a force of 5 kN. It may also comprise a plastic ferrule nut slidably mounted on each leg proximal to each locking ring, such nut comprising an external thread which is complementary to that of the insert and a plurality of pre-formed holes for gripping the nut so that the nut can be tightened on the thread of said insert so as to securely but reversibly hold the step iron in place on the concrete structure in such a manner so that the security of such hold is visible to the naked eye. The nut of the step iron apparatus may comprise a tamper-evident cavity adapted to disfigure said plastic of the nut if an attempt is made to remove the step after initial installation.

The invention also provides a step iron apparatus for a concrete structure comprising an insert and a step iron: the insert being made from polypropylene or polyethylene and substantially ring-shaped and comprising an internal thread and a plurality of apertures to enable it to be fixed within formwork and embeddable within a concrete structure without protruding therefrom; the step iron being of substantially U-shape and comprising a body and a plurality of legs; the body and legs each comprising a steel core fully encapsulated in high impact polypropylene or high density polyethylene; the body comprising an elongate tread length to enable a user to use the step iron for climbing; the step iron comprising vertical upstands located substantially laterally on the tread length to prevent a person's foot slipping off the end of the step iron, said upstands being approximately 25 mm in height and approximately 59 mm in length; the rear of the tread length comprising a series of raised profiles to improve the handhold of a person gripping the tread length in use; the legs each comprising a proximal end nearer the body and a distal end; the distal end of each leg comprising an end section to abut a complementary section of the insert; a disc shaped locking ring centrally located on the axis of each leg just proximal to the end section, the locking ring being able to withstand a force of 5 kN and being approximately 40 mm in diameter and approximately 6.8 mm thick; a polypropylene or polyethylene ferrule nut slidably mounted on each leg proximal to each locking ring, such nut comprising an external thread which is complementary to that of the insert and a plurality of pre-formed holes for gripping the nut so that the nut can be tightened on the thread of said insert so as to securely but reversibly hold the step iron in place on the concrete structure in such a manner so that the security of such hold is visible to the naked eye; wherein the preformed holes are approximately 5 mm in diameter and the nut comprises a tamper-evident cavity of approximately 10 mm length such that the plastic of the nut within the cavity and adjacent to each such hole is of 2 mm thickness, the cavity thereby adapted to disfigure said plastic of the nut if an attempt is made to remove the step after initial installation.

In some embodiments, there is provided a step iron apparatus for a concrete structure comprising an insert and a step iron; the insert being fixable and embeddable within a concrete structure; the step iron comprising a body and a plurality of legs; the body and legs each comprising a metal core fully encapsulated in a plastic material; the body comprising an elongate tread length to enable a user to use the step iron for climbing; the legs each comprising a proximal end nearer the body and a distal end; the distal end of each leg comprising an end section to abut an insert which is fixable within formwork and embeddable within a concrete structure without protruding therefrom; a locking ring centrally located on the axis of each leg just proximal to the end section; a plastic ferrule nut slidably mounted on each leg proximal to each locking ring, such nut comprising an external thread which is complementary to that of the insert and a means for gripping the nut so that the nut can be tightened on the thread of said insert so as to securely but reversibly hold the step iron in place on the concrete structure.

The invention also provides a step iron apparatus for a concrete structure comprising an insert and a step iron; the insert being fixable and embeddable within a concrete structure; the step iron comprising a body and a plurality of legs; the body and legs each comprising a steel core fully encapsulated in a plastic material; the body comprising an elongate tread length to enable a user to use the step iron for climbing; the step iron comprising vertical upstands located substantially laterally on the tread length to prevent a person's foot slipping off the end of the step iron; the rear of the tread length comprising a series of raised profiles to improve the handhold of a person gripping the tread length in use; the legs each comprising a proximal end nearer the body and a distal end; the distal end of each leg comprising an end section to abut a complementary section of a substantially ring-shaped polypropylene or polyethylene insert which comprises an internal thread and a plurality of apertures to enable it to be fixed within formwork and embeddable within a concrete structure without protruding therefrom; a locking ring centrally located on the axis of each leg just proximal to the end section, the locking ring being able to withstand a force of 5 kN; a plastic ferrule nut slidably mounted on each leg proximal to each locking ring, such nut comprising an external thread which is complementary to that of the insert and a plurality of pre-formed holes for gripping the nut so that the nut can be tightened on the thread of said insert so as to securely but reversibly hold the step iron in place on the concrete structure in such a manner so that the security of such hold is visible to the naked eye; wherein the nut comprises a tamper-evident cavity adapted to disfigure said plastic of the nut if an attempt is made to remove the step after initial installation.

The invention also provides a method of installing a step iron comprising: fixing a step insert according to the invention to the internal formwork of the concrete structure using nails for wooden formwork or magnets for steel formwork; passing steel reinforcement through the exterior holes of the step insert; tying the steel reinforcement into the steel reinforcement of the structure; placing concrete into the formwork; allowing said concrete to cure; removing said formwork and thereby exposing the opening of the step insert on the inside face of a structure walls; inserting the legs of the step iron into the recess of the step insert until the locking ring is seated hard inside the step insert; tightening the ferrule not using the appropriate tool until it is secure against the locking ring.

The invention also provides a method of manufacturing a step iron comprising injecting a molten polymer material into a mould cavity to at least partially encapsulate a metal step iron core; and adding a fixing to a leg of the step iron to enable reversible engagement with a complementary section of a step iron insert.

The method of manufacture may comprise cutting a section of rectangular steel to a desired length corresponding with the core of the step iron. It may also comprise bending said step iron core into a generally U-shape comprising a tread length and two legs. It may also comprise opening the ejection half and injection half of the mould body and inserting the step iron core into the injection half of the mould body. In some embodiments the method comprises holding the step iron core in place using magnets at the end of each leg of the step iron.

The method of manufacture may comprise closing the ejection half and the injection half of the mould body so as to form a mould cavity enclosing the tread length and each leg of the step iron wherein the cavity formed around each step leg terminates at a point above the locking rings to allow the ferrule nut to be placed over the step legs after the first injection process. The method may also comprise injecting molten high impact polypropylene or molten high density polyethylene into the mould cavity whereby the material flows into the mould cavity evenly and thereby encapsulates the core of the step iron comprising the tread length and a portion of each step leg to a position above the locking ring, and leaves a portion of the steel core on each leg unencapsulated. It may also comprise opening the ejection half and injection half of the mould body and ejecting the step iron comprising the encapsulated tread length and a portion of each step leg to a position above the locking ring.

In some embodiments, the method comprises sliding a ferrule nut over each step leg and it may also comprise re-positioning the step iron and gripping with a bracket to secure the tread length and with strong magnets to grip each step leg through the injected plastic along the leg.

The method of manufacture may comprise closing the ejection half and the injection half of the mould body so as to form a mould cavity enclosing the end of each leg of the step iron extending to the portion of each leg where the steel core is unencapsulated plus several millimetres of the previously injected plastic so as to meld it together into one unit, the mould forming a seal at the outside circumference of the portion of each step leg that has previously been encapsulated.

The method of manufacture may comprise injecting molten high impact polypropylene or molten high density polyethylene into the mould cavity enclosing the end portion of each leg of the step iron and forming the locking ring on each step leg and thereby creating a complete seal encapsulating the entire steel core of the step insert.

The method of manufacture may comprise opening the ejection half and injection half of the mould body and ejecting the step iron comprising of a fully encapsulated step iron, comprising a tread length and each step leg with a locking ring and ferrule nut integral to the whole assembly.

The invention also provides a method of manufacturing a step iron comprising: cutting a section of rectangular steel to a desired length corresponding with the core of the step iron; bending said step iron core into a generally U-shape comprising a tread length and two legs;

opening the ejection half and injection half of the mould body and inserting the step iron core into the injection half of the mould body; holding the step iron core in place using magnets at the end of each leg of the step iron; closing the ejection half and the injection half of the mould body so as to form a mould cavity enclosing the tread length and each leg of the step iron wherein the cavity formed around each step leg terminates at a point above the locking rings to allow the ferrule nut to be placed over the step legs after the first injection process; injecting molten high impact polypropylene or molten high density polyethylene into the mould cavity whereby the material flows into the mould cavity evenly and thereby encapsulates the core of the step iron comprising the tread length and a portion of each step leg to a position above the locking ring, and leaves a portion of the steel core on each leg unencapsulated; opening the ejection half and injection half of the mould body and ejecting the step iron comprising the encapsulated tread length and a portion of each step leg to a position above the locking ring; sliding a ferrule nut over each step leg; re-positioning the step iron and gripping with a bracket to secure the tread length and with strong magnets to grip each step leg through the injected plastic along the leg; closing the ejection half and the injection half of the mould body so as to form a mould cavity enclosing the end of each leg of the step iron extending to the portion of each leg where the steel core is unencapsulated plus several millimetres of the previously injected plastic so as to meld it together into one unit, the mould forming a seal at the outside circumference of the portion of each step leg that has previously been encapsulated; injecting molten high impact polypropylene or molten high density polyethylene into the mould cavity enclosing the end portion of each leg of the step iron and forming the locking ring on each step leg and thereby creating a complete seal encapsulating the entire steel core of the step insert;

opening the ejection half and injection half of the mould body and ejecting the step iron comprising of a fully encapsulated step iron, comprising a tread length and each step leg with a locking ring and ferrule nut integral to the whole assembly.

In some preferred embodiments, the invention provides a step iron comprising a body and a plurality of legs, the legs comprising fixing means to fix each leg in secure engagement with an insert in the wall of a concrete structure.

Preferably the fixing means is reversible so as to allow the steps to be removed and replaced as required during construction. However, such reversibility should not compromise safety and therefore the strength of the engagement with the wall. A preferred fixing means is a threaded engagement between a component of the step iron and the wall or a component associated with the wall. In some preferred embodiments, there is provided a ferrule nut which has a threaded/screw-in engagement with the wall or a component associated therewith. Preferably each of the legs of the step iron comprise such a ferrule nut. In some preferred embodiments the ferrule nut comprises a means for tightening, such as a portion for gripping or attachment or engagement with a hand or more preferably a tool to provide a tight threaded grip with the wall or wall component. In some preferred embodiments, the means for tightening comprises a plurality of holes for engagement with a suitable tool in order to rotate and therefore tighten the ferrule nut. Preferably there is also provided a tightening ring and preferably on each leg of the step iron, and preferably a ferrule nut can tighten against such ring in order to ensure a close, locking engagement. In some preferred embodiments there is also provided a tamper-evident feature associated with the fixing means. For example, for embodiments which comprise a ferrule nut, it may comprise a physical feature which is deformable when rotational force is applied to the nut in order to loosen it. In some embodiments this may comprise a slot or other suitable feature.

The body (or tread length) of the step iron must be shaped so as to enable a person to use it as a step and hand hold in the same way as using a ladder. Various shapes may be accordingly used, provided they meet safety requirements. The profile of the body may be of any suitable shape, provided, again that it is fit for purpose. In some embodiments, the shape is such as to provide additional grip for feet and/or hands as the user traverses the steps. Raised profiles may for example be used for this purpose. Other suitable features can be added in various preferred embodiments, for example upstands in order to reduce the risk of a foot or hand slipping off the end of the tread length/body during use.

In some preferred embodiments the step iron comprises a suitable metal material, preferably steel and is at least partially encapsulated with a polymer material. The polymer may be of any suitable type which for example provides protection for weathering and rust, sufficient grip for hands and feet and insulation against electrical conductivity. In some preferred embodiments, the step iron is at least partially encapsulated with a polypropylene or polyethylene. More preferably, high impact polypropylene is used. Any suitable method can be used to at least partially encapsulate the step iron, but it has been found that injection moulding is a preferred method.

In some aspects of the invention there is provided an insert for a wall of a concrete structure to receive a step iron, preferably of the invention. An insert according to the invention preferably has complementary features to those of the step iron so as to provide for reversible fixed engagement. For example, the insert may comprise a threaded section to match that of a ferrule nut of a step iron leg as described herein.

The insert of the invention may be fixable to the wall of the concrete structure in any suitable manner. In certain preferred embodiments, it is cast into the wall as the wall itself is made. For example, it may be cast into the concrete of the wall. Accordingly an insert according to the invention may comprise features which enable such fixation to be sufficiently strong so as to withstand all required forces once a step iron has been fixed to it. Thus for example, it may comprise features to enable it to be set securely within concrete, such as external protuberances which will lock into the concrete when it has set. In some preferred embodiments an insert according to the invention comprises an aperture to enable more secure fixing, for example by attachment to a steel framework or formwork.

In some preferred aspects of the invention there is provided a step iron system comprising a step iron and an insert as described herein.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIGS. 1A to 1E depict various aspects of a preferred embodiment of the step iron component of the invention.

FIGS. 2A to 2C depict various aspects of a preferred embodiment of the step insert component of the invention.

FIGS. 3A to 3E depict various aspects of a preferred embodiment of the ferrule nut component of the invention

FIG. 4 depicts the assembly of the components described in FIGS. 1A to 3E.

### DETAILED DESCRIPTION OF EXEMPLARY EMBODIMENTS

It is convenient to describe the invention herein in relation to particularly preferred embodiments. However, the invention is applicable to a wide range of embodiments and it is to be appreciated that other constructions and arrangements are also considered as falling within the scope of the invention. Various modifications, alterations, variations and or additions to the construction and arrangements described herein are also considered as falling within the ambit and scope of the present invention.

According to some preferred embodiments, the invention consists of an improved steel reinforced, plastic encapsulated step iron used in combination with threaded plastic step inserts and a ferrule nut. The plastic step inserts are cast into the walls of the concrete structures. The step legs are then inserted into the step plug inserts and the ferrule nut is tightened to secure the step in place. The system of the invention is much safer than prior art systems, in particular in relation to minimum pull-out force.

Since the step is secured by means of a threaded system rather than through permanent embedment into a concrete wall it can be easily removed by persons working inside the structures, allowing them enough working space inside the structures. The steps can be easily re-inserted while being able to guarantee ongoing compliance with pull-out force safety requirements.

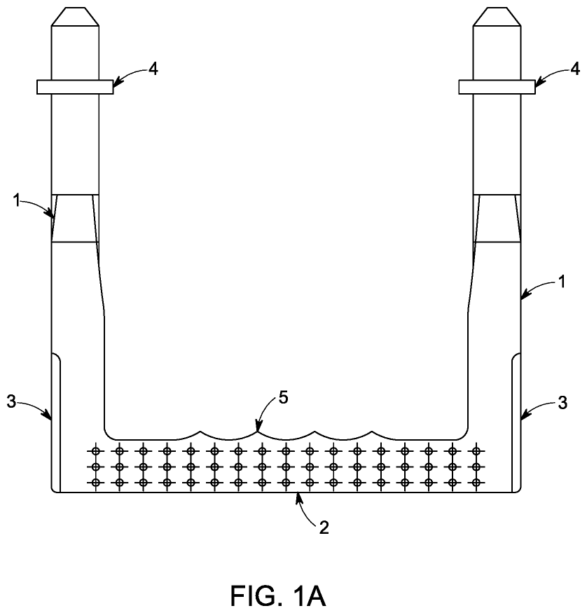

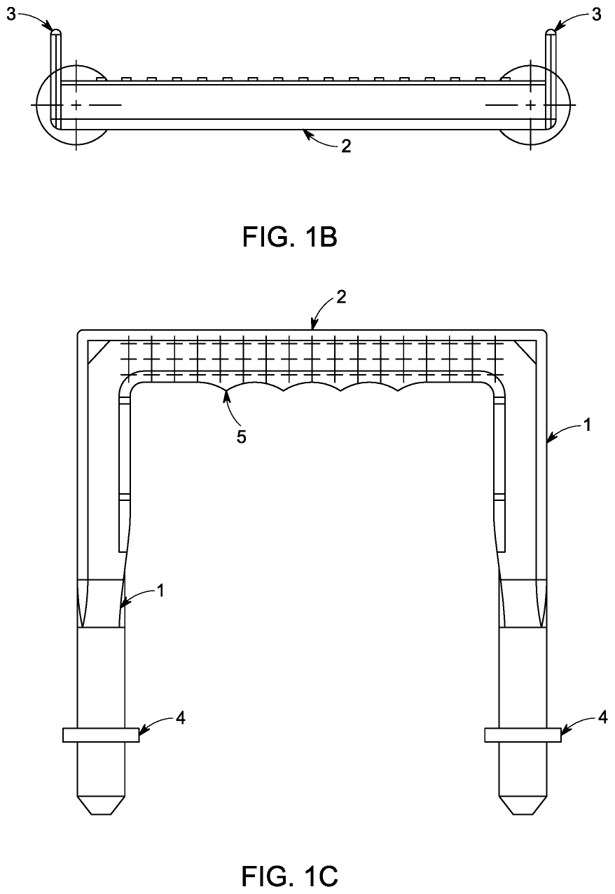

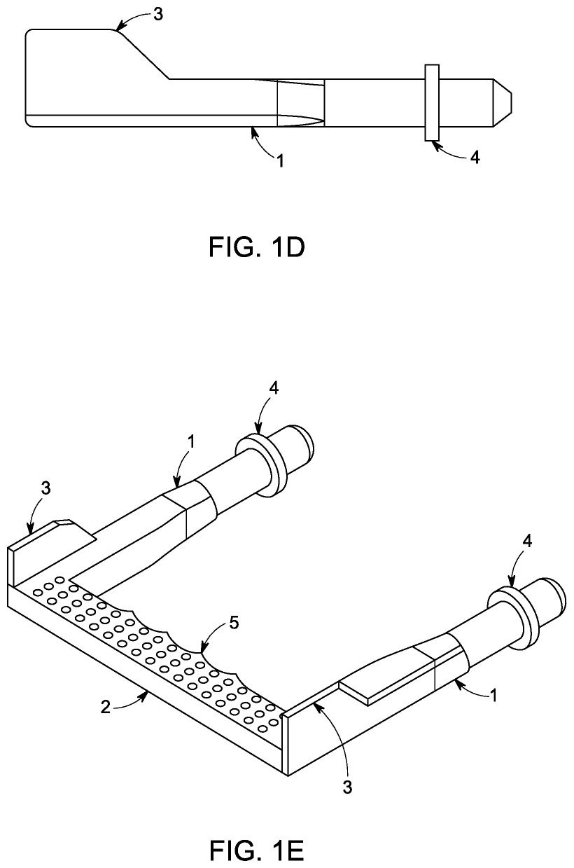

With reference to FIG. 1, the step iron component of the invention comprises a generally U-shape design consisting of 2 legs (1) and a tread length (2). The structure of this step is a steel reinforced core fully encapsulated in plastic, preferably high impact polypropylene. Other types of plastic are also suitable, for example, polyethylene or polypropylene. The steps are encapsulated to prevent corrosion of the steel core and to ensure there is no electrical conductivity in the steps. From a manufacturing standpoint, some plastics can be less preferable, for example standard polypropylene can be too brittle under impact and can crack and some plastics can be ‘too slippery’. In some embodiments, steps can be manufactured from steel, cast iron or aluminium with corrosion protection applied. It has been found that plastic encapsulation through plastic injection moulding is preferable. By using a mould, the manufacturing process can be undertaken with very tight tolerances, in particular with the threaded components. It is possible but less preferable to use steel, aluminium or cast iron, however it is more difficult to obtain such tight tolerances and it may necessitate that the components are hand-made with more variance in the end product. Further, using these materials without plastic encapsulation creates the potential for corrosion, compromising structural integrity of the materials and therefore creating safety risks.

The step iron also comprises vertical upstands (3) that prevent a person's foot from slipping off the end of the step iron when in use. Vertical upstands according to the invention are preferably at least 20 mm in height, and preferably in the range 20 to 30 mm and in some embodiments in the range 20 mm to 50 mm. A particularly preferred embodiment as depicted in FIG. 1d is 25 mm in height. The length of the vertical upstands (measurement along the leg (1) of the step iron) is preferably at least 50 mm, and preferably in the range 55 to 65 mm. It has been found that a length of about 58 mm or 59 mm is preferred and a length of 58.79 mm is depicted in FIG. 1D.

Additionally, the rear of the tread length (2) incorporates a series of raised profiles (5) to improve the handhold of a person as they descend and ascend into and out of the structures incorporating the invention.

The legs of the step iron also comprise a locking ring (4) that forms part of the locking mechanism for the step. In some preferred embodiments, the locking rings are 40 mm in diameter and 6.84 mm thick (refer dimensions shown in FIG. 1A). However, it will be appreciated that a range of suitable dimensions are possible, for example approximately 30 mm to 50 mm in diameter and approximately 5 to 10 mm thick. For safety reasons, the locking ring should ideally withstand a minimum force of 5 kN (500 kg).

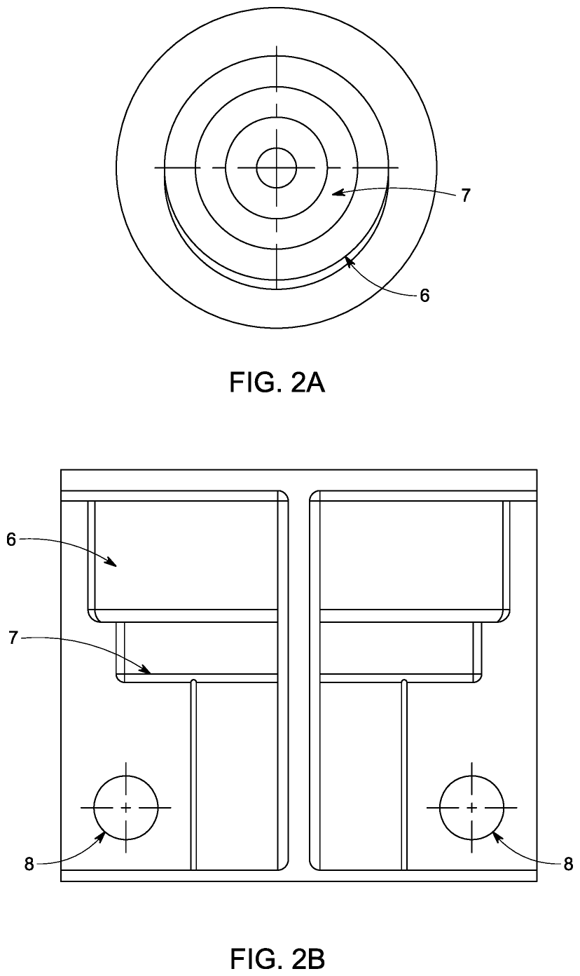

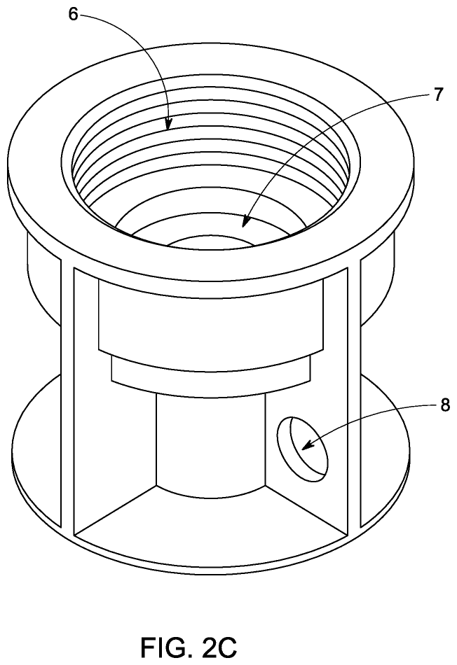

With reference to FIG. 2, the step insert component of the invention is comprised of plastic, preferably polypropylene that is designed to be cast into the walls of the concrete structures. Polypropylene is preferable as this component will be made by plastic injection moulding and for the same reasons we use polypropylene to encapsulate the steel core of the step (as described above). Steel is less preferable as each item would most likely have to be hand made and therefore tolerances would be out, in particular for the threaded component. Additionally within concrete structures exposed steel is not optimal as it will rust and risks transferring the rust to the steel reinforcing inside the concrete of the structure causing concrete cancer and compromising the integrity of the structure. Further, this would also potentially cause electrical conductivity issues as described above for the step component.

In some embodiments, the step inserts can be fixed to the internal formwork of the structure prior to concrete placement using nails for wooden formwork and magnets for steel formwork.

In one preferred embodiment, the insert comprises a threaded recess (6) and a cavity (7) that is designed to accept the legs of the step iron component (1). Further, the insert contains holes in the exterior (8) designed to allow the steel reinforcement of the concrete structures to pass through, thereby securing the insert into the wall of the structure.

In some embodiments, steps would first be fixed to the inner formwork using nails or magnets. As the person constructing the structure builds the steel reinforcement they would pass reinforcement bars through these holes and tie this to the reinforcement of the structure. It should be noted that this is not a critical step and it could potentially work without the exterior holes but this would provide additional support to ensure that the step inserts don't move when the concrete is placed into the formwork.

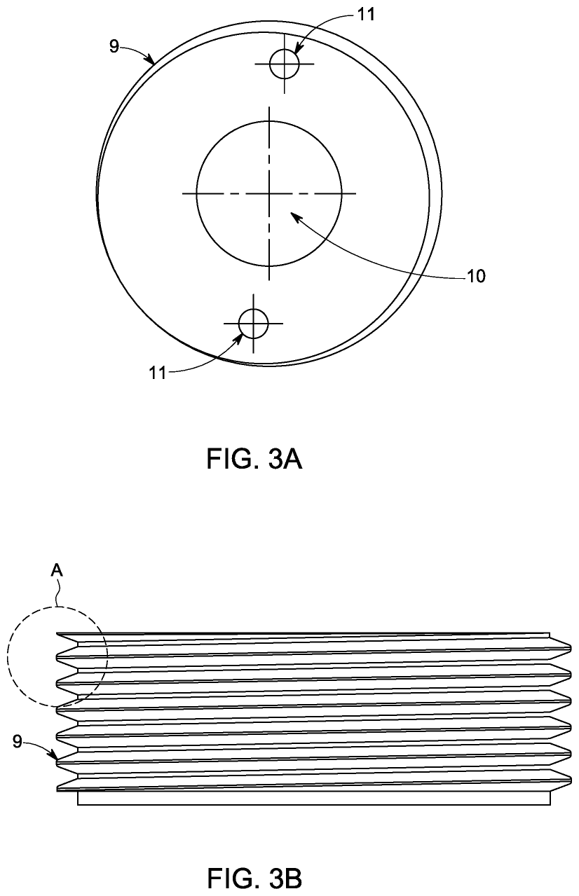

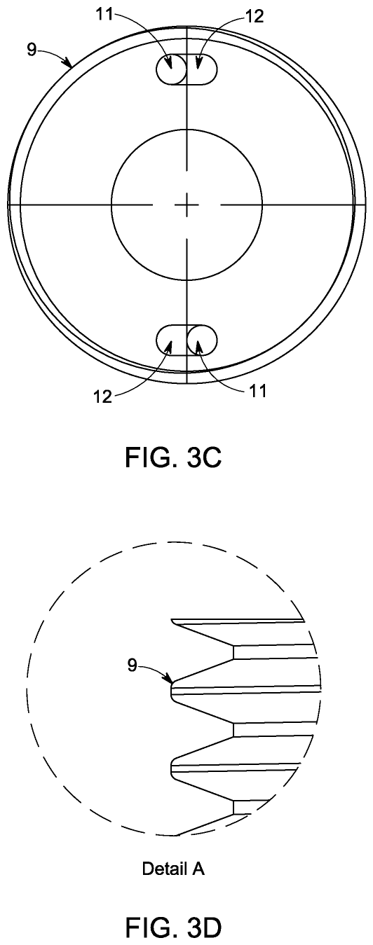

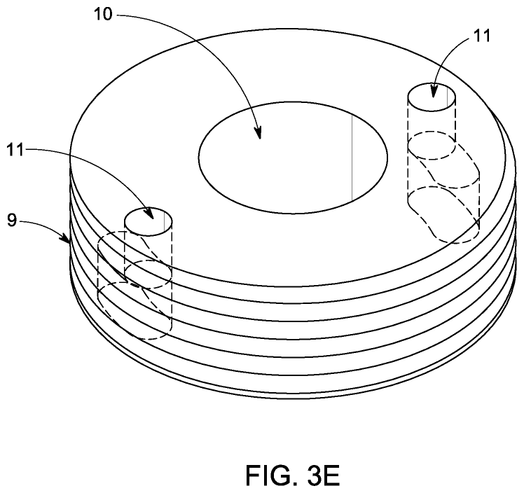

With reference to FIG. 3, the ferrule nut component of the invention is preferably comprised of plastic, preferably polypropylene consisting of a threaded exterior face (9) that matches the threaded recess of the step insert (6), a central hole (10) designed to fit over the leg of the step iron (1) above the locking ring (4). There are also included pre-formed holes (11) to allow the tightening of the ferrule nut into the threaded section of the step insert (6).

These pre-formed holes have an additional cavity at the rear (12) (see FIG. 3C) that will disfigure if attempts are made to remove the step after initial installation, thereby showing evidence of tampering. The cavity as shown in FIG. 3C is approximately 10 mm long. Turning to FIG. 3A it is evident that the hole at the top is 5 mm diameter. However the plastic at the surface is only approximately 2 mm thick. When force is applied against it in order to loosen the step and remove it, that thin piece of plastic will deform and elongate from a round 5 mm diameter hole to the 10 mm long cavity.

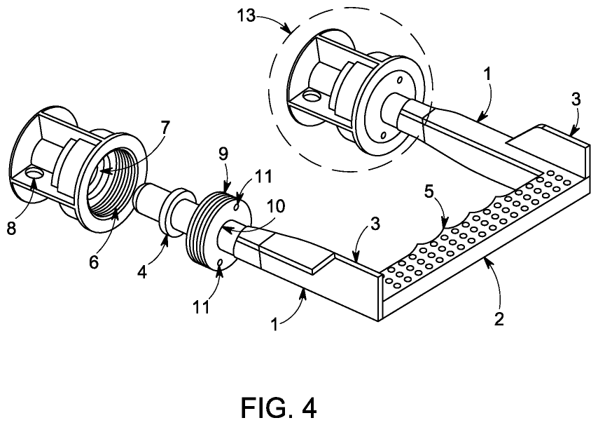

FIG. 4 depicts an example embodiment of the invention as an assembly of the components described in FIGS. 1 to 3. The assembly depicts how the ferrule nut shown in FIG. 3 fits over the leg of the step iron insert (1) above the locking ring (4). The assembly contains an exploded view which shows how the leg of the step iron (1) component is inserted into the step insert until the locking ring (4) seats hard inside the cavity (7). The ferrule nut is then tightened using the pre-formed holes (11) until the nut presses hard against the locking ring (4) thereby securing the step in place. Item (13) depicts how this preferred embodiment of the invention appears once the nut has been tightened.

In practice, the invention can for example be installed as follows:
(a) the step inserts (FIG. 2C) are fixed to the internal formwork of the concrete structure using nails for wooden formwork or magnets for steel formwork. The location of the step inserts, vertical spacing etc. within the structure itself are done in accordance with standard safety principles and the requirements of the particular site.
(b) Steel reinforcement is passed through the exterior holes of the step insert and tied into the steel reinforcement of the structure.
(c) After the concrete is placed into the formwork and cured the formwork is removed, thus exposing the opening of the step insert on the inside face of the structure walls.
(d) The legs of the step are inserted into the recess of the step insert until the locking ring is seated hard inside the step insert.
(e) Using the appropriate tool, the ferrule nut is tightened until it is secure against the locking ring.

Example of manufacture method.

The steel core may for example be comprised of a standard straight rectangular section of steel. It is then cut to the desired length and bent into a U-shape. It is then inserted into a plastic injection mould with the first moulding encapsulating the step iron legs and locking ring. It is then removed from the mould and the ferrule nuts are placed onto the legs. The step is then placed back into the mould and the remainder of the step is encapsulated through plastic injection moulding.

An example method for this step is as follows:

(a) opening the ejection half and injection half of the mould body and inserting the step iron core into the injection half of the mould body;

(b) holding the core of the step iron in place using magnets at the end of each leg of the step iron;

(c) closing the ejection half and the injection half of the mould body so as to form a mould cavity enclosing the tread length and each leg of the step iron. The cavity formed around each step leg terminates at a point above the locking rings to allow the ferrule nut to be placed over the step legs after the first injection process;

(d) injecting a molten material, preferably high impact polypropylene into the mould cavity whereby the material flows into the mould cavity evenly, encapsulating the core of the step iron comprising the tread length and a portion of the each step leg to a position above the locking ring, leaving a portion of the steel core on each leg exposed;

(e) opening the ejection half and injection half of the mould body and ejecting the step iron comprising the encapsulated tread length and a portion of each step leg to a position above the locking ring;

(f) sliding a ferrule nut over each step leg. The ferrule nut is formed in a separate injection mould in a single injection process;

(g) re-positioning the step iron and gripping via a bracket to secure the tread length and strong magnets to grip each step leg through the injected plastic along the leg;

(h) closing the ejection half and the injection half of the mould body so as to form the mould cavity enclosing the end of each leg of the step iron extending only to the portion of each leg where the steel core remains exposed and includes a few millimetres of the previously injected plastic to meld together into one unit. The mould forms a seal at outside circumference of the portion of each step leg that has been encapsulated in the first injection moulding process;

(i) injecting a molten material, preferably high impact polypropylene into the mould cavity enclosing the end portion of each leg of the step iron and forming the locking ring on each step leg. Each step leg is encapsulated to a position extending from the termination of the moulding from the first process, ensuring an overlap in the moulding and the plastic melds together as a single piece, creating a complete seal encapsulating the entire steel core of the step insert;

(j)) opening the ejection half and injection half of the mould body and ejecting the step iron comprising of a fully encapsulated step iron, comprising a tread length and each step leg with a locking ring and ferrule nut integral to the whole assembly.

What is claimed is:

1. A step iron for a concrete structure, the step iron comprising a body and a leg;
the body and leg each comprising a metal core and at least partially encapsulated in a polymer material;
the body comprising a tread length to enable a user to use the step iron for climbing;
the leg comprising a proximal end nearer the body and a distal end;
the distal end of the leg comprising an end section to abut a complementary section of an insert which is fixable and embeddable within a concrete structure;
a fixing means mounted on the leg to enable reversible engagement with a complementary section of the insert.

2. (canceled)

3. A step iron according to claim 1 comprising a metal core fully encapsulated in a plastic material;

4. (canceled)

5. A step iron according to claim 1 wherein the distal end of each leg comprises an end section to abut an insert which is fixable within formwork and embeddable within a concrete structure without protruding therefrom.

6. A step iron according to claim 1 comprising a locking ring centrally located on the axis of each leg just proximal to the end section.

7. A step iron according to claim 1 comprising a plastic ferrule nut slidably mounted on each leg proximal to a locking ring, such nut comprising an external thread which is complementary to that of the insert and a means for gripping the nut so that the nut can be tightened on the thread of said insert so as to securely but reversibly hold the step iron in place on the concrete structure.

8. A step iron according to claim 1 comprising vertical upstands located substantially laterally on the tread length to prevent a person's foot slipping off the end of the step iron.

9. (canceled)

10. A step iron according to claim 1 wherein the distal end of the leg comprises an end section to abut a complementary section of a substantially ring-shaped polypropylene or polyethylene insert which comprises an internal thread and a plurality of apertures to enable it to be fixed within formwork and embeddable within a concrete structure without protruding therefrom.

11. A step iron according to claim 1 comprising a locking ring centrally located on the axis of each leg just proximal to the end section, the locking ring being able to withstand a force of 5 kN.

12. A step iron according to claim 1 comprising a plastic ferrule nut slidably mounted on each leg proximal to each locking ring, such nut comprising an external thread which is complementary to that of the insert and a plurality of pre-formed holes for gripping the nut so that the nut can be tightened on the thread of said insert so as to securely but reversibly hold the step iron in place on the concrete structure in such a manner so that the security of such hold is visible to the naked eye.

13. A step iron according to claim 1 comprising a ferrule nut and wherein the nut comprises a tamper-evident cavity adapted to disfigure said plastic of the nut if an attempt is made to remove the step after initial installation.

14.-16. (canceled)

17. A step iron apparatus for a concrete structure comprising an insert and a step iron:
the insert being fixable and embeddable within a concrete structure;
the step iron comprising a body and a leg;
the body and leg each comprising a metal core and at least partially encapsulated in a polymer material;
the body comprising a tread length to enable a user to use the step iron for climbing;
the leg comprising a proximal end nearer the body and a distal end;
the distal end of the leg comprising an end section to abut a complementary section of the insert;
a fixing means mounted on the leg to enable reversible engagement with a complementary section of the insert.

18. (canceled)

19. A step iron apparatus according to claim 17 comprising a metal core fully encapsulated in a plastic material;

20. (canceled)

21. A step iron apparatus according to claim 17 wherein the distal end of each leg comprises an end section to abut an insert which is fixable within formwork and embeddable within a concrete structure without protruding therefrom.

22. A step iron apparatus according to claim 17 comprising a locking ring centrally located on the axis of each leg just proximal to the end section.

23. A step iron apparatus according to claim 17 comprising a plastic ferrule nut slidably mounted on each leg proximal to a locking ring, such nut comprising an external thread which is complementary to that of the insert and a means for gripping the nut so that the nut can be tightened on the thread of said insert so as to securely but reversibly hold the step iron in place on the concrete structure.

24. step iron apparatus according to claim 17 comprising vertical upstands located substantially laterally on the tread length to prevent a person's foot slipping off the end of the step iron.

25. (canceled)

26. A step iron apparatus according to claim 17 wherein the distal end of the leg comprises an end section to abut a complementary section of a substantially ring-shaped polypropylene or polyethylene insert which comprises an internal thread and a plurality of apertures to enable it to be fixed within formwork and embeddable within a concrete structure without protruding therefrom.

27. A step iron apparatus according to claim 17 comprising a locking ring centrally located on the axis of each leg just proximal to the end section, the locking ring being able to withstand a force of 5 kN.

28. A step iron apparatus according to claim 17 comprising a plastic ferrule nut slidably mounted on each leg proximal to each locking ring, such nut comprising an external thread which is complementary to that of the insert and a plurality of pre-formed holes for gripping the nut so that the nut can be tightened on the thread of said insert so as to securely but reversibly hold the step iron in place on the concrete structure in such a manner so that the security of such hold is visible to the naked eye.

29. A step iron apparatus according to claim 17 comprising a ferrule nut and wherein the nut comprises a tamper-evident cavity adapted to disfigure said plastic of the nut if an attempt is made to remove the step after initial installation.

30.-47. (canceled)
